(19) United States
(12) Patent Application Publication
(10) Pub. No.: US 2008/0093479 A1
(43) Pub. Date: Apr. 24, 2008

(54) Locking Ring for Spray Gun Connector

(76) Inventors: Neil Delbridge, Warwickshire (GB); Mark William Ackley, East Aurora, NY (US); Jeffert John Nowobilski, Orchard Park, NY (US)

Correspondence Address: 3M INNOVATIVE PROPERTIES COMPANY, PO BOX 33427, ST. PAUL, MN, 55133-3427, US

(21) Appl. No.: 11/576,817

(22) PCT Filed: Aug. 30, 2005
(86) PCT No.: PCT/US05/30923

§ 371 Date: Apr. 6, 2007

(30) Foreign Application Priority Data
Oct. 8, 2004 (GB) 0422388.9

(51) Int. Cl. B05B 7/24; F16L 37/244

(52) U.S. Cl. 239/302

(57) ABSTRACT

A connector assembly for releasably securing a reservoir to a spray gun includes a spout 119 on a lid 114 of the reservoir received in a socket of an inlet adaptor 105 on the spray gun, and a locking ring 144 located on the inlet adaptor 105 that screws onto the lid 114 to secure the lid 114 to the adaptor 105.

### FIELD OF THE INVENTION

This invention concerns improvements in or relating to liquid spraying apparatus such as a spray gun. More especially, the invention relates to the connection between the spray gun and a reservoir containing the liquid to be sprayed. The invention has particular application to a releasable connection for detachably mounting the reservoir on the spray gun and in particular, but not exclusively a suction feed spray gun.

### BACKGROUND OF THE INVENTION

Spray guns are widely used in vehicle body repair shops when re-spraying a vehicle that has been repaired following an accident. In the known spray guns, the liquid is contained in a reservoir attached to the gun from where it is fed to a spray nozzle. On emerging from the spray nozzle, the liquid is atomised and forms a spray with compressed air supplied to the nozzle. The liquid may be gravity fed or suction fed or, more recently, pressure fed by an air bleed line to the reservoir from the compressed air line to the spray gun.

Traditionally, the liquid is contained in a rigid pot mounted on the spray gun by engagement of complementary screw threads on the pot and gun. In this way, the pot can be removed for cleaning or replacement. Typically, the pot is secured to the gun empty and has a removable lid by means of which the liquid can be added to the pot while attached to the gun. On completion of spraying, the pot can be removed and the gun and pot cleaned for re-use.

Such screw threaded connection requires the reservoir to be rotated several times, typically at least four or five turns, to engage fully the threads and secure the reservoir in a fluid tight manner. This is time consuming and requires considerable care and dexterity on the part of the user to prevent spillage when the reservoir is full of liquid. Also, on completion of spraying, careful cleaning is required to remove all traces of liquid from the threads to prevent the threads becoming blocked, for example with dried paint, and to prevent cross-contamination with the liquid next sprayed.

Blocked threads may render the gun unusable requiring the purchase of a new gun. This adds to costs and is inconvenient if time is lost because a spare gun is not to hand to continue spraying. Moreover, cleaning of the threads usually requires solvents that are also used to clean the gun and pot. The use of solvents is undesirable from health and safety considerations and causes problems for disposal of the solvent after use.

We have developed a system for connecting the reservoir to the gun via a releasable quick-fit connection employing one or more retainer legs on the lid of the reservoir with hook formations at the distal ends that locate behind a flange on an inlet adaptor screwed into the gun to connect the reservoir to the gun. The flange is provided with cut-outs in the perimeter for connecting/disconnecting the hook formations with a push-twist action requiring less than one complete turn of the reservoir in a manner similar to a bayonet connection.

This arrangement enables the reservoir to be attached to and detached from the gun in a simple, efficient manner that requires less dexterity on the part of the user. Although this arrangement works well, the integrity of the connection may be compromised if the reservoir is inadvertently rotated to a position in which the hook formations are no longer fully engaged with the flange with the result that the reservoir may detach from the spray gun. In particular, in a suction feed spray gun, the reservoir hangs vertically down under the gun and can detach from the spray gun, especially when full of liquid, if it is inadvertently rotated to a position in which the hook formations are partially or fully disengaged.

Accidental release of the reservoir leading to separation of the reservoir from the spray gun may result in paint spillage requiring cleaning and possible re-working of the surface being sprayed. This adds to costs both in terms of materials used and the time taken to spray the surface to achieve an acceptable finish. Even if the reservoir does not physically separate from the spray gun, the efficiency of the fluid-tight seal between the reservoir and gun may be reduced resulting in leakage of paint requiring cleaning of the gun and/or reservoir and possible re-working of the surface being sprayed.

### SUMMARY OF THE INVENTION

The present invention has been made from a consideration of the above-described prior art methods for securing a reservoir to a spray gun.

More particularly, embodiments of the present invention provide an improved connection between a spray gun and reservoir that reduces the risk of accidental release of the reservoir.

Furthermore, at lease some embodiments of the present invention provide such improved connection between the gun and reservoir that enables the reservoir to be attached to and detached from the gun in a simple manner.

Moreover, at least some embodiments of the present invention provide such improved connection between the gun and reservoir that enable the position of the reservoir to be adjusted relative to the spray gun.

Additionally, at least some embodiments of the present invention provide such improved connection having application to different types of spray gun and reservoir.

According to one aspect of the present invention, there is provided liquid spraying apparatus comprising a spray gun and a reservoir connected to the spray gun for supplying liquid to the spray gun, the spray gun having an inlet and the reservoir having an outlet engaged with the inlet, wherein the inlet and the outlet are provided with respective connector portions and the spraying apparatus further includes a locking ring located on one of the connector portions and engageable with the other connector portion to secure releasably the reservoir to the spray gun, and wherein the said other connector portion and the locking ring have mateable multi-start screw threads engageable with less than one complete turn of the locking ring.

By this invention, the locking ring secures the reservoir to the spray gun such that the integrity of the connection between the spray gun inlet and the reservoir outlet is maintained and unintentional separation of the reservoir from the spray gun is prevented.

As used herein, the term “liquid” refers to all forms of flowable materials that can be applied to a surface using a spray gun (whether or not they are intended to colour the surface) including (without limitation) paints, primers, base coats, lacquers, varnishes and similar paint-like materials as well as other materials such as adhesives, sealers, fillers, putties, powder coatings, blasting powders, abrasive slurries, mould release agents and foundry dressings which may be applied in atomised or non-atomised form depending on the properties and/or the intended application of the material and the term “liquid” is to be construed accordingly.

Preferably, the outlet is provided by a spout at one end of the reservoir and the inlet is provided by a socket on the gun, the spout being a push fit in the socket and rotatable relative to the socket while maintaining a fluid tight seal therebetween. The socket may be provided by an inlet adaptor having a threaded portion engaged with a complementary threaded portion on the spray gun to secure releasably the inlet adaptor to the spray gun.

Preferably, the locking ring is axially located on the inlet adaptor and is rotatable relative to inlet adaptor to engage/disengage the connector portion on the reservoir, and the connector portion on the reservoir and inlet adaptor are urged together when the locking ring is tightened to secure the reservoir and prevent relative rotation between the spout and socket.

Preferably, the connector portion on the reservoir comprises an annular boss and the spout projects from the boss into the socket of the inlet adaptor, and the inlet adaptor has a flange that locates the locking ring and seats on the boss around the spout when the locking ring is tightened to secure the reservoir to the spray gun. In a preferred arrangement, the flange and boss have opposed flat faces that are urged together to resist rotation of the spout in the socket when the locking ring is tightened to secure the reservoir to the spray gun.

Preferably, the reservoir comprises a container having an opening at one end and a lid that closes the opening, and the spout and boss are integral with the lid. The lid may be made of plastics material and the inlet adaptor and locking ring made of metal. The lid may be provided with an inlet having a removable screw cap to permit liquid to be added to the reservoir while connected to the spray gun. The container may be provided with a liner, and the liner is removable with the lid.

According to a further aspect of the present invention, there is provided liquid spraying apparatus comprising a spray gun and a reservoir connected to the spray gun for supplying liquid to the spray gun, the spray gun having an inlet and the reservoir having an outlet engaged with the inlet, wherein the inlet and the outlet are provided with respective connector portions and the spraying apparatus further includes a locking ring located on the inlet connector portion, the locking ring being provided with a screw thread engageable with a screw thread on the outlet connector portion to secure releasably the reservoir to the spray gun.

Preferably, the screw threads on the locking ring and outlet connector portion are multi-start screw threads that are fully engaged/disengaged by less than one complete turn of the locking ring.

Preferably, the outlet is provided by a spout at one end of the reservoir and the inlet is provided by a socket on the gun, the spout being a push fit in the socket and rotatable relative to the socket while maintaining a fluid tight seal therebetween. The socket may be provided by an inlet adaptor having a threaded portion engaged with a complementary threaded portion on the spray gun to secure releasably the inlet adaptor to the spray gun.

Preferably, the locking ring is axially located on the inlet adaptor and is rotatable relative to inlet adaptor to engage/disengage the outlet connector portion, and the outlet connector portion and inlet adaptor are urged together when the locking ring is tightened to secure the reservoir and prevent relative rotation between the spout and socket.

Preferably the outlet connector portion comprises an annular boss and the spout projects from the boss into the socket of the inlet adaptor, and the inlet adaptor has a flange that locates the locking ring and seats on the boss around the spout when the locking ring is tightened to secure the reservoir to the spray gun. In a preferred arrangement, the flange and boss have opposed flat faces that are urged together to resist rotation of the spout in the socket when the locking ring is tightened to secure the reservoir to the spray gun.

Preferably, the reservoir comprises a container having an opening at one end and a lid that closes the opening, and the spout and outlet connector portion are integral with the lid. The lid may be made of plastics material and the inlet adaptor and locking ring made of metal. The lid may be provided with an inlet having a removable screw cap to permit liquid to be added to the reservoir while connected to the spray gun. The container may be provided with a liner, and the liner is removable with the lid.

According to yet another aspect of the present invention, there is provided liquid spraying apparatus comprising a spray gun and a reservoir connected to the spray gun for supplying liquid to the spray gun, the spray gun having an inlet and the reservoir having an outlet engaged with the inlet to provide a fluid tight connection between the reservoir and the spray gun while permitting rotation of the reservoir relative to the spray gun to adjust the position of the reservoir relative to the spray gun, wherein the inlet and the outlet are provided with respective connector portions and the spraying apparatus further includes a locking ring located on one of the connector portions and engageable with the other connector portion to secure the reservoir relative to the spray gun in an adjusted position, wherein the adjusted position can be changed by partially releasing the locking ring from the said other connector portion to permit rotation of the reservoir relative to the spray gun while maintaining the fluid tight connection therebetween.

Preferably, the outlet is provided by a spout at one end of the reservoir and the inlet is provided by a socket on the gun, the spout being a push fit in the socket and rotatable relative to the socket while maintaining the fluid tight connection therebetween. The socket may be provided by an inlet adaptor having a threaded portion engaged with a complementary threaded portion on the spray gun to secure releasably the inlet adaptor to the spray gun.

Preferably, said other connector portion is provided on the reservoir and the locking ring is axially located on the inlet adaptor and is rotatable relative to inlet adaptor to engage/disengage the connector portion. For example, the locking ring may have a screw thread engageable with a screw thread on said other connector portion to secure releasably the reservoir to the spray gun. In a preferred embodiment, the screw threads are multi-start screw threads that are fully engaged/disengaged by less than one complete turn of the locking ring.

Preferably, said other connector portion and inlet adaptor are urged together when the locking ring is tightened to secure the reservoir and prevent relative rotation between the spout and socket. For example, said other connector portion may comprise an annular boss, the spout projecting from the boss for insertion in the socket of the inlet adaptor, and the inlet adaptor has a flange that locates the locking ring and seats on the boss around the spout when the locking ring is tightened to secure the reservoir to the spray gun. The flange and boss may have opposed flat faces that are urged together to resist rotation of the spout in the socket when the locking ring is tightened to secure the reservoir to the spray gun.

Preferably, the reservoir comprises a container having an opening at one end and a lid that closes the opening, and the spout and connector portion are integral with the lid. The lid may be made of plastics material and the inlet adaptor and locking ring made of metal. The lid may be provided with an inlet having a removable screw cap to permit liquid to be added to the reservoir while connected to the spray gun. The container may be provided with a liner, and the liner is removable with the lid.

From another aspect, the present invention provides a connector assembly for releasably connecting a liquid reservoir to liquid spraying apparatus to permit liquid to be withdrawn from the reservoir in use, the connector assembly comprising a first part having a male connector member defining a connection axis and a second part having a female connector member to receive the male connector member to place the first and second parts in fluid communication, the male and female connector members permitting relative rotation between the first and second parts about the connection axis, and one of the first and second parts having a locking ring engageable with the other of the first and second parts to secure releasably the first and second parts together to prevent separation of the first and second parts in a direction parallel to the connection axis and to prevent relative rotation between the first and second parts about the connection axis.

Preferably, the second part is provided with an external flange that locates the locking ring axially on the second part and the first part is provided with an external screw thread engageable with an internal screw thread on the locking ring to secure the first and second parts together when the male connector member is received in the female connector member. Preferably the screw threads are multi-start screw threads engageable with less than one complete turn of the locking ring.

Preferably, the external screw thread on the first part is provided by an annular boss and opposed flat faces of the flange and boss are urged together when the locking ring is tightened to clamp the connector members together preventing separation of the first and second parts in a direction parallel to the connection axis and preventing relative rotation between the first and second parts about the connection axis.

Preferably, the male connector member is provided on a part of the reservoir, for example a lid, and the female connector member is provided on a part of the gun, for example an inlet adaptor. The inlet adaptor may be permanently secured to the gun but more preferably the inlet adaptor is releasably secured to the gun. For example, the inlet adaptor may be screwed into an inlet port on the gun.

Preferably, a fluid tight seal is provided between the male and female connector members to prevent leakage of liquid while permitting relative rotation between the male and female connector members. For example the male connector member may be provided with one or more annular ribs for sealing engagement with the female connector member.

Preferably, the male connector member provides the fluid outlet from the reservoir, for example a spout on the lid, and the female connector member provides a fluid inlet to the gun, for example a socket in the inlet adaptor to receive the spout and permit rotation of the spout in the socket to rotate the reservoir about the connection axis. For example, the spout and socket may be of matching cylindrical or frusto-conical shape.

Preferably, the spout is offset from the central longitudinal axis of the reservoir. In this way, the angular position of the reservoir relative to the gun can be adjusted by rotating the reservoir about the connection axis and the reservoir can be secured in any adjusted position by tightening the locking ring.

Preferably, the locking ring can be partially released to permit rotation of the reservoir about the connection axis while preventing axial separation of the spout and socket sufficient to disconnect the spout.

Preferably, the lid is provided with an inlet having a removable screw cap to permit liquid to be added to the reservoir while connected to the spray gun.

Access to the inlet may be improved by rotation of the reservoir about the connection axis.

Preferably, the reservoir includes a removable liner, and the lid and liner can be thrown away to reduce the amount of cleaning required after use.

From yet another aspect, the present invention provides a method of releasably connection a liquid reservoir to liquid spraying apparatus to permit liquid to be withdrawn from the reservoir in use, the method comprising providing a first part having a male connector member defining a connection axis on one of the reservoir and spray gun and a second part having a female connector member on the other of the reservoir and spray gun, inserting the male connector member in the female connector member to place the reservoir in fluid communication with the spray gun, and securing the first and second pats together with a locking ring to prevent separation of the first and second parts in a direction parallel to the connection axis.

Preferably, the locking ring is provided on one of the parts and has a multi-start screw thread engageable with a complementary multi-start screw thread on the other part to secure the parts together with less than one complete turn of the locking ring.

From a still further aspect, present invention provides liquid spraying apparatus comprising a spray gun and a reservoir connected to the spray gun to permit liquid to be withdrawn from the reservoir in use, a first part having a male connector member defining a connection axis on one of the reservoir and spray gun, a second part having a female connector member on the other of the reservoir and spray gun, the male connector member being received in the female connector member to place the reservoir in fluid communication with the spray gun, and a locking ring on one of the parts, the locking ring being rotatable about the connection axis and engageable with the other part to prevent separation of the first and second parts in a direction parallel to the connection axis.

Preferably, the first part is a lid of the reservoir and the second part is an inlet adaptor on the gun, the inlet adaptor having a socket to receive a spout on the lid, and the locking ring is axially located by a flange on the inlet adaptor and has a screw thread engageable with a threaded boss on the lid to urge opposed flat faces of the flange and boss together.

Other features, benefits and advantages of the invention will be apparent from the following detailed description of exemplary embodiments of the invention with reference to the accompanying drawings.

### BRIEF DESCRIPTION OF THE DRAWINGS

FIG. 1 is a perspective view of a suction feed spray gun and reservoir provided with a known releasable connector assembly according to the prior art;

FIG. 2 is a longitudinal section through the reservoir shown in FIG. 1;

FIG. 3 is an end view of the inlet adaptor shown in FIG. 1;

FIG. 4 is an exploded perspective view of the component parts of a connector system according to the present invention for securing a reservoir to a spray gun; and

FIG. 5 is a perspective view showing the connector system of FIG. 4 assembled.

### DETAILED DESCRIPTION OF THE EXEMPLARY EMBODIMENTS

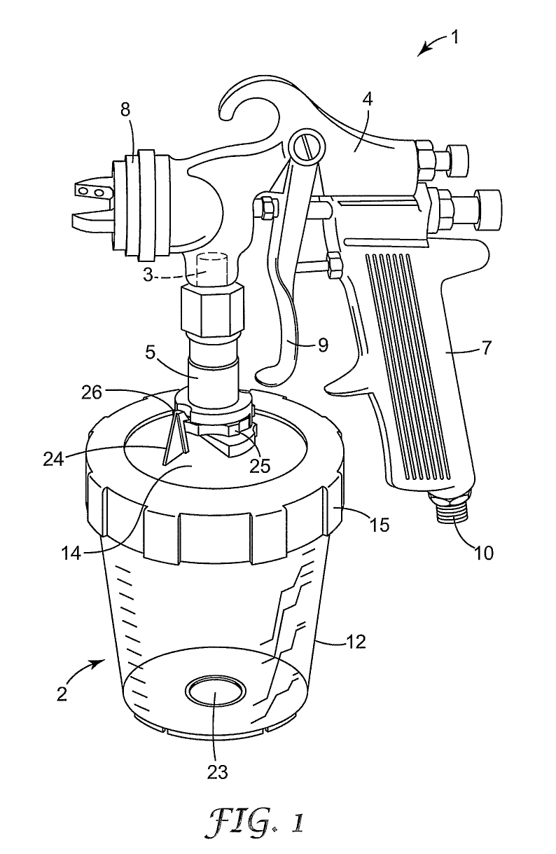

Referring first to FIGS. 1 to 3 of the accompanying drawings, there is shown a spray gun 1 of the suction feed type and a reservoir 2 connected to an inlet port 3 on the underside of the spray gun body 4 via an inlet adaptor 5. The inlet adaptor 5 comprises a tubular body with an external screw thread (not shown) at one end engageable with a complementary internal screw thread (not shown) on the inlet port 3 to secure the adaptor 5 to the spray gun 1. Alternatively, the inlet adaptor 5 may have a threaded socket to receive a threaded boss on the gun 1 to connect the inlet adaptor 5 to the inlet port 3. The inlet adaptor 5 has external flats for engagement with a spanner or similar tool to assist in attaching/detaching the inlet adaptor 5. The reservoir 2 is releasably connected to the other end of the inlet adaptor 5 as described in more detail later.

The gun 1 has a handle 7 that extends downwards from the rear end of the body 4, and a spray nozzle 8 at the front end of the body. The gun 1 is manually-operated by a trigger 9 which is pivotally-mounted on the sides of the gun. The inlet port 3 is arranged between the trigger 9 and the spray nozzle 8. In use, the gun 1 is connected via a connector 10 at the lower end of the handle 7 to a source of compressed air (not shown) and the reservoir 2 contains paint or other liquid to be sprayed. Compressed air is delivered through the gun 1 to the nozzle 8 when the user pulls on the trigger 9 and paint is delivered from the reservoir 2 through the gun 1 to the nozzle 8 by suction. The paint is atomised on leaving the nozzle 8 to form a spray with the compressed air emerging from the nozzle 8.

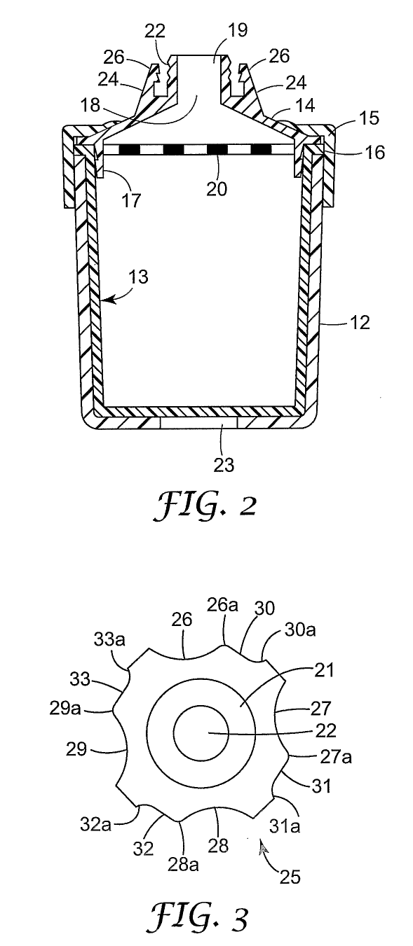

At best shown in FIG. 2 of the drawings, the reservoir 2 includes an outer container 12, a disposable liner 13, a disposable lid 14 and a collar 15. The liner 13 corresponds in shape to (and is a close fit in) the interior of the container 12 and has a narrow rim 16 at the open end that sits on the top edge of the container 12.

The lid 14 is of conical shape and has a dependent skirt 17 inset from the peripheral edge. The skirt 17 is a push-fit in the open end of the liner 13 to locate the peripheral edge of the lid 14 over the rim 16 of the liner 13. The lid/liner assembly is secured in place by screwing the annular collar 15 onto the container 12 on top of the lid 14. The lid 14 has a central aperture 18 at the apex that leads to a tube or spout 19 providing a fluid outlet. A mesh filter 20 is arranged to remove particulate material from paint delivered through the spout 19 to the spray gun 1 in use. In this embodiment, the filter 20 is a push fit in the skirt 17 but it will be understood this is not essential and the filter 20 may be a push-fit in the spout 19 or may be an integral part of the lid 14. For some applications, the filter 20 may not be required and can be omitted.

The spout 19 is a push fit in a socket 21 (see FIG. 3) at the end of the inlet adaptor 5 remote from the spray gun 1 and has a pair of external annular ribs 22 that provide a fluid-tight seal within the socket 21. In an alternative arrangement (not shown), a fluid-tight seal may be obtained by one or more sealing rings, for example O-rings, located in groove(s) on the spout 19 or in the wall of the socket 21. The inlet adaptor 5 has a though bore 22 that extends from the socket 21 to the other end for transferring liquid withdrawn from the reservoir 2 to the spray gun 1.

In use, the liner 13 collapses in an axial direction towards the lid 14 as paint is withdrawn from the reservoir 2. A vent hole 23 in the base of the outer container 12 allows air to enter as the liner 13 collapses. On completion of spraying, the reservoir 2 can be detached from the spray gun 1, the collar 15 released and the lid/liner assembly removed from the outer container 12 in one piece. The outer container 12 and collar 15 are left clean and ready for re-use with a fresh liner 13 and lid 14. In this way, extensive cleaning of the reservoir 2 may be avoided.

The lid/liner assembly may be used to store any paint remaining for a short period of time and re-assembled with the container 12 and collar 15 for attachment to the spray gun 1 to use the remaining paint. Alternatively, the lid/liner assembly can be thrown away when all the paint has been used or is no longer required. The reservoir with collapsible liner forms the subject matter of our published International patent application No. WO98/32539 the contents of which are incorporated herein by reference and to which the reader is directed for further details and explanation.

The reservoir 2 is releasably connected to the inlet adaptor 5 by engagement of a pair of hook members 24 (see FIG. 2) on the lid 14 with an external flange 25 on the inlet adaptor 5. As best shown in FIG. 3, the flange 25 comprises four arcuate recesses 26, 27, 28, 29 uniformly spaced in a circumferential direction around the outer periphery such that the recesses 26, 28 are opposite each other and the recesses 27, 29 are opposite each other. Each recess 26, 27, 28, 29 leads in a clockwise direction (as viewed in FIG. 3) via a cam lobe 26a, 27a, 28a, 29a at the end of the recess 26, 27, 28, 29 to a flat 30, 31, 32, 33 that terminates in an abutment 30a, 31a, 32a, 33a.

The hook members 24 are disposed on opposite sides of the spout tube 19 such that, to secure the reservoir 2 to the spray gun 1, the hook members 24 are aligned with a pair of opposed recesses 26, 28 or 27, 29 in the flange 25. The spout tube 19 is then pushed into the socket 21 so that enlarged heads 34 at the distal ends of the hook members 24 pass through the aligned recesses 26, 28 or 27, 29. The reservoir 2 is then rotated relative to the spray gun 1 to cause the hook members 24 to ride over the cam lobes 26a, 28a or 27a, 29a and locate the heads 34 behind the flats 30, 32 or 31, 33. In this way, the reservoir 2 is secured to the adaptor 5 with the reservoir outlet in communication with the spray gun inlet. The engagement of the heads 34 behind the flats 30, 32, or 31, 33 resists axial separation of the reservoir 2 from the adaptor 5 in use of the spray gun 1. On completion of spraying, the reservoir 2 can be detached from the spray gun 1 by reversing the above operation. The releasable connection provided by the hook members 24 and flange 25 forms the subject matter of our published International patent application No. WO01/012337 the contents of which are incorporated herein by reference and to which the reader is directed for further details and explanation.

In use, the engagement of the hook members 24 and the flange 25 could be accidentally released if the reservoir 2 is inadvertently rotated so that the heads 34 of the hook members 24 are aligned with the recesses 26, 28 or 27, 29. For example, the reservoir 2 may be rotated by knocking or brushing against the side of the reservoir 2 as the spray gun 1 is manoeuvred during painting. The force required to rotate the reservoir 2 may not be very great, especially when the reservoir 2 is full of liquid or if the hook members 24 are not fully engaged when attaching the reservoir 2. Also, the force required to rotate the reservoir 2 may be reduced as a result of the contacting surfaces of the hook members 24 becoming worn over time or due to a poor initial fit.

As a result, unintentional separation of the reservoir 2 from the spray gun 1 may occur causing paint spillage. For example, accidental rotation of the reservoir 2 to align the hook members 24 with the recesses 26, 28 or 27, 29 may allow the spout 19 to come out of the socket 21 under gravity due to the weight of the reservoir 2 and liquid contained therein. This is inconvenient as not only must any spillage be cleaned up but the finish of the surface being painted may be affected requiring re-working.

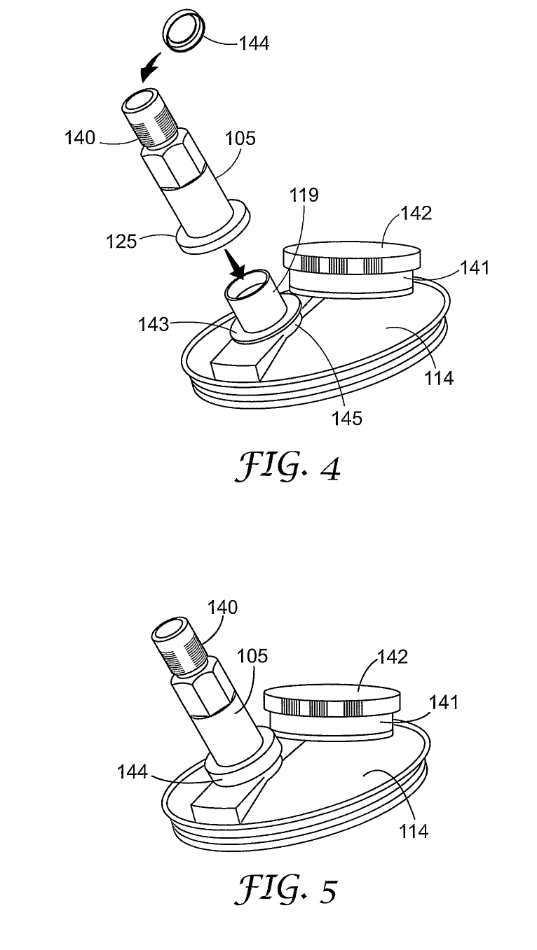

Referring now to FIGS. 4 and 5, there is shown a connector system according to the present invention for securing a reservoir to a spray gun. For convenience, only parts of the reservoir employed in the connector system are shown and described. Where appropriate, like reference numerals in the series 100 are used to indicate parts corresponding to the previous embodiment.

The connector system is shown applied to an inlet adaptor 105 and a lid 114 of a reservoir (not shown) for connecting the reservoir to a spray gun (not shown). The reservoir may be of the type described above with a collapsible liner but it will be understood this is not essential and the connector system may be applied to any type of reservoir for connection to a spray gun or similar liquid spraying apparatus. Likewise, the spray gun may be of the suction feed type described above or any other type familiar to those skilled in the art such as a gravity feed or pressure feed spray gun.

The inlet adaptor 105 is made of metal, for example aluminium and has an external screw thread 140 at one end for engagement with a complementary internal screw thread of an inlet port on the spray gun to secure releasably the inlet adaptor 105 to the spray gun. The inlet port may be provided on the underside of the body of a suction feed spray gun as described previously or on the topside of the body of a gravity feed spray gun.

The lid 114 is made of plastics, for example polypropylene and has an outlet in the form of a cylindrical spout 119 that is a push fit in a socket (not shown) at the end of the inlet adaptor 105 remote from the screw thread 140. The lid 114 is also provided with an inlet in the form of a spout 141 having a removable screw cap 142 by means of which liquid can be added to the reservoir while attached to the spray gun. It will be understood, however, that the inlet spout 141 is not essential and can be omitted, for example where the reservoir has a detachable lid as described previously.

In this embodiment, the inlet and outlet spouts 141, 119 are offset from and inclined relative to the central longitudinal axis of the lid 114 and the inlet spout 141 is of larger diameter than the outlet spout 119. This arrangement facilitates access to the inlet opening 141 when the reservoir is connected to the gun and permits rapid filling of the reservoir. The provision of an inlet for filling the reservoir forms the subject matter of our published International patent application No. WO 02/085533 the contents of which are incorporated herein by reference and to which the reader is directed for further details and explanation.

The lid 114 has an annular boss 143 at the base of the spout 119 and the inlet adaptor 105 has an annular flange 125 with a diameter matching that of the boss 143. The flange 125 seats on the boss 143 when the spout 119 is inserted in the socket of the adaptor 105 and the lid 114 is secured to the inlet adaptor 105 by a locking ring 144. The locking ring 144 is made of metal and fits over the body of the inlet adaptor 105 and is retained by the flange 125. The locking ring 144 has an internal screw thread (not shown) complementary to an external screw thread 145 on the boss 143. The boss 143 and locking ring 144 are provided with multi-start threads that are engageable to secure the locking ring 144 with less than one complete turn of the locking ring 144 enabling the lid 114 to be connected/disconnected quickly and easily.

In use, a reservoir provided with the lid 114 is secured in position when the locking ring 144 is tightened to clamp the opposed flat faces 125a, 143a of the flange 125 and boss 143 together such that rotation of the spout 119 in the socket is resisted by the friction generated between the opposed contacting faces 125a,143a of the flange 125 and boss 143. As a result, the reservoir can be firmly secured in any desired position relative to the gun. The position of the reservoir can be adjusted if required without detaching the reservoir from the adaptor 105 by partially releasing the locking ring 144 allowing the spout 119 to rotate in the socket through 360 degrees about the connection axis. The arrangement of the sealing ribs (not shown) on the spout tube 119 allows such rotation without compromising the efficiency of the seal thereby preventing leakage of liquid while the position of the reservoir is adjusted. The reservoir can be secured after adjusting the position by re-tightening the locking ring 144 to clamp the opposed faces of the flange 125 and boss 143 together. The position of the reservoir may be adjusted in use to provide access to the inlet spout 141 when it is desired to add liquid to the reservoir. Also, the position of the reservoir may be adjusted in use to provide optimum balance for holding and manoeuvring the spray gun and/or to ensure the outlet remains below the level of liquid in the reservoir.

As will now be appreciated, the invention enables a reservoir to be releasably secured to a spray gun in a reliable manner that reduces the risk of accidental disconnection of the reservoir. This is of particular benefit for suction feed spray guns where the reservoir hangs down from the gun and can separate from the gun if it is not properly secured.

Moreover, the simple construction and operation of the invention has advantages for the manufacturer and end user. In particular, no special profiling (machining) of the flange on the inlet adaptor is required and no retainer legs with hook formations are required on the lid. As a result, manufacture of the inlet adaptor and lid is simplified with potential cost savings. Furthermore, the locking ring provides a robust connection that is resistant to damage if the reservoir is dropped or mishandled. As a result, service life of the inlet adaptor and lid may be increased with potential cost savings.

It will be understood that the invention is not limited to the embodiment above-described. For example, the male and female connectors on the lid and adaptor may have any suitable shape. Thus, where rotation of the reservoir about the connection axis is desired, the male and female connections may be cylindrical as described or frusto-conical.

For some applications, however, rotation of the reservoir may not be required and in this case the male and female formations may provide a push fit connection that resists rotation. Generally, however at least some rotation is desirable to allow the reservoir to be secured in the optimum position for spraying.

The male and female connectors on the lid and adaptor may be reversed so that the male connector is on the gun and the female connector is on the reservoir. The male and females connectors may be made of any suitable materials including metal, plastics or composites thereof.

The connector (male or female) on the reservoir may be provided on a lid of the reservoir as described or any other suitable part of the reservoir depending on the construction of the reservoir. The connector (male or female) on the gun may be provided on a detachable part of the gun as described or it may provided on an integral (permanent) part of the gun.

The flange locating the locking ring may be provided on the part having the female connector as described or on the part having the male connector. All possible options and combinations of male and female connectors with locking ring are envisaged as being within the scope of the invention.

The locking ring may be provided with a multi-start screw thread as described to permit connection/disconnection with less than one complete turn as described or with any other type of screw thread or similar formation for releasably securing the locking ring and applying an axial clamping force to the parts that are connected together. For example, the locking ring may be provided with a cam groove or rib co-operable with a cam follower. Other arrangements will be apparent to those skilled in the art.

Other modifications and improvements that can be made within the spirit and scope of the invention as generally described herein will be apparent to those skilled in the art.

1. A liquid spraying apparatus comprising a spray gun and a reservoir connected to the spray gun for supplying liquid to the spray gun, the spray gun having an inlet and the reservoir having an outlet engaged with the inlet, wherein the inlet and the outlet are provided with respective connector portions and the spraying apparatus further includes a locking ring located on one of the connector portions and engageable with the other connector portion to secure releasably the reservoir to the spray gun, and wherein the said other connector portion and the locking ring have mateable multi-start screw threads engageable with less than one complete turn of the locking ring.

2. A liquid spraying apparatus according to claim 1 wherein, the outlet is provided by a spout at one end of the reservoir and the inlet is provided by a socket on the gun, the spout being a push fit in the socket and rotatable relative to the socket while maintaining a fluid tight seal therebetween.

3. A liquid spraying apparatus according to claim 2 wherein, the socket is provided by an inlet adaptor having a threaded portion engaged with a complementary threaded portion on the spray gun to secure releasably the inlet adaptor to the spray gun.

4. A liquid spraying apparatus according to claim 3 wherein, the said other connector portion is provided on the reservoir and the locking ring is axially located on the inlet adaptor and is rotatable relative to inlet adaptor to engage/disengage the connector portion.

5. A liquid spraying apparatus according to claim 4 wherein the said other connector portion and inlet adaptor are urged together when the locking ring is tightened to secure the reservoir and prevent relative rotation between the spout and socket.

6. A liquid spraying apparatus according to claim 4 wherein, the reservoir comprises a container having an opening at one end and a lid that closes the opening, and the spout and the said other connector portion are integral with the lid.

7. A liquid spraying apparatus according to claim 6 wherein the said other connector portion comprises an annular boss and the spout projects from the boss into the socket of the inlet adaptor, and the inlet adaptor has a flange that locates the locking ring and seats on the boss around the spout when the locking ring is tightened to secure the reservoir to the spray gun.

8. A liquid spraying apparatus according to claim 7 wherein the flange and boss have opposed flat faces that are urged together to resist rotation of the spout in the socket when the locking ring is tightened to secure the reservoir to the spray gun.

9. A liquid spraying apparatus according to claim 6 wherein the lid is made of plastic material and the inlet adaptor and locking ring are made of metal.

10. A liquid spraying apparatus according to claim 6 wherein the lid is provided with an inlet having a removable screw cap to permit liquid to be added to the reservoir while connected to the spray gun.

11. A liquid spraying apparatus according to claim 6, wherein the container is provided with a liner, and the liner is removable with the lid.

12. A liquid spraying apparatus according to claim 1 wherein, the spray gun is selected from the group comprising gravity feed, suction feed and pressure feed spray guns.

13. A liquid spraying apparatus comprising a spray gun and a reservoir connected to the spray gun for supplying liquid to the spray gun, the spray gun having an inlet and the reservoir having an outlet engaged with the inlet, wherein the inlet and the outlet are provided with respective connector portions and the spraying apparatus further includes a locking ring located on the inlet connector portion, the locking ring being provided with a screw thread engageable with a screw thread on the outlet connector portion to secure releasably the reservoir to the spray gun.

14. A liquid spraying apparatus according to claim 13 wherein the screw threads on the locking ring and outlet connector portion are multi-start screw threads that are fully engaged/disengaged by less than one complete turn of the locking ring.

15. A liquid spraying apparatus according to claim 13 wherein, the outlet is provided by a spout at one end of the reservoir and the inlet is provided by a socket on the gun, the spout being a push fit in the socket and rotatable relative to the socket while maintaining a fluid tight seal therebetween.

16. A liquid spraying apparatus according to claim 15 wherein, the socket is provided by an inlet adaptor having a threaded portion engaged with a complementary threaded portion on the spray gun to secure releasably the inlet adaptor to the spray gun.

17. A liquid spraying apparatus according to claim 16 wherein, the locking ring is axially located on the inlet adaptor and is rotatable relative to inlet adaptor to engage/disengage the outlet connector portion.

18. A liquid spraying apparatus according to claim 17 wherein the outlet connector portion and inlet adaptor are urged together when the locking ring is tightened to secure the reservoir and prevent relative rotation between the spout and socket.

19. A liquid spraying apparatus according to claim 17, the reservoir comprises a container having an opening at one end and a lid that closes the opening, and the spout and outlet connector portion are integral with the lid.

20. A liquid spraying apparatus according to claim 19 wherein the outlet connector portion comprises an annular boss and the spout projects from the boss into the socket of the inlet adaptor, and the inlet adaptor has a flange that locates the locking ring and seats on the boss around the spout when the locking ring is tightened to secure the reservoir to the spray gun.

21. A liquid spraying apparatus according to claim 20 wherein the flange and boss have opposed flat faces that are urged together to resist rotation of the spout in the socket when the locking ring is tightened to secure the reservoir to the spray gun.

22. A liquid spraying apparatus according to claim 19 wherein the lid is made of plastics material and the inlet adaptor and locking ring are made of metal.

23. A liquid spraying apparatus according to claim 19 wherein the lid is provided with an inlet having a removable screw cap to permit liquid to be added to the reservoir while connected to the spray gun.

24. A liquid spraying apparatus according to claim 19, wherein the container is provided with a liner, and the liner is removable with the lid.

25. A liquid spraying apparatus according to claim 13 wherein, the spray gun is selected from the group comprising gravity feed, suction feed and pressure feed spray guns.

26. A liquid spraying apparatus comprising a spray gun and a reservoir connected to the spray gun for supplying liquid to the spray gun, the spray gun having an inlet and the reservoir having an outlet engaged with the inlet to provide a fluid tight connection between the reservoir and the spray gun while permitting rotation of the reservoir relative to the spray gun to adjust the position of the reservoir relative to the spray gun, wherein the inlet and the outlet are provided with respective connector portions and the spraying apparatus further includes a locking ring located on one of the connector portions and engageable with the other connector portion to secure the reservoir relative to the spray gun in an adjusted position, wherein the adjusted position can be changed by partially releasing the locking ring from the said other connector portion to permit rotation of the reservoir relative to the spray gun while maintaining the fluid tight connection therebetween.

27. A liquid spraying apparatus according to claim 26 wherein, the outlet is provided by a spout at one end of the reservoir and the inlet is provided by a socket on the gun, the spout being a push fit in the socket and rotatable relative to the socket while maintaining the fluid tight connection therebetween.

28. A liquid spraying apparatus according to claim 27 wherein, the socket is provided by an inlet adaptor having a threaded portion engaged with a complementary threaded portion on the spray gun to secure releasably the inlet adaptor to the spray gun.

29. A liquid spraying apparatus according to claim 28 wherein, said other connector portion is provided on the reservoir and the locking ring is axially located on the inlet adaptor and is rotatable relative to inlet adaptor to engage/disengage the connector portion.

30. A liquid spraying apparatus according to claim 27 wherein the locking ring has a screw thread engageable with a screw thread on said other connector portion to secure releasably the reservoir to the spray gun.

31. A liquid spraying apparatus according to claim 30 wherein the screw threads are multi-start screw threads that are fully engage/disengaged by less than one complete turn of the locking ring.

32. A liquid spraying apparatus according to claim 30 wherein said other connector portion and inlet adaptor are urged together when the locking ring is tightened to secure the reservoir and prevent relative rotation between the spout and socket.

33. A liquid spraying apparatus according to claim 27 wherein, the reservoir comprises a container having an opening at one end and a lid that closes the opening, and the spout and said other connector portion are integral with the lid.

34. A liquid spraying apparatus according to claim 33 wherein said other connector portion comprises an annular boss and the spout projects from the boss for insertion in the socket of the inlet adaptor, and the inlet adaptor has a flange that locates the locking ring and seats on the boss around the spout when the locking ring is tightened to secure the reservoir to the spray gun.

35. A liquid spraying apparatus according to claim 34 wherein the flange and boss have opposed flat faces that are urged together to resist rotation of the spout in the socket when the locking ring is tightened to secure the reservoir to the spray gun.

36. A liquid spraying apparatus according to claim 33 wherein the lid is made of plastics material and the inlet adaptor and locking ring are made of metal.

37. A liquid spraying apparatus according to claim 33 wherein the lid is provided with an inlet having a removable screw cap to permit liquid to be added to the reservoir while connected to the spray gun.

38. A liquid spraying apparatus according to claim 33, wherein the container is provided with a liner, and the liner is removable with the lid.

39. A liquid spraying apparatus according to claim 26 wherein, the spray gun is selected from the group comprising gravity feed, suction feed and pressure feed spray guns.

40. (canceled)
